(19) United States
(12) Patent Application Publication
(10) Pub. No.: US 2006/0287212 A1
(43) Pub. Date: Dec. 21, 2006

(54) Blends of inactive particles and active particles

(75) Inventors: Christian Sommer, Gilleleje (DK); Erik Kjaer Markussen, Vaerlose (DK); Ole Simonsen, Soborg (DK); Poul Bach, Birkerod (DK); Robert van der Lans, Valby (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 11/445,913

(22) Filed: Jun. 2, 2006

Related U.S. Application Data
(60) Provisional application No. 60/689,171, filed on Jun. 10, 2005.

(30) Foreign Application Priority Data
Jun. 2, 2005 (DK) PA 2005 00805

(51) Int. Cl. C11D 3/00

(52) U.S. Cl. 510/392; 435/186

(57) ABSTRACT

The present invention relates to a blend of particles comprising at least two different kinds of particles: particles comprising an active compound and inactive particles comprising a coating. The inactive particles are used to control the activity strength of particulate materials comprising active compounds.

### CROSS-REFERENCE TO RELATED APPLICATIONS

This application claims priority or the benefit under 35 U.S.C. 119 of Danish application no. PA 2005 00805 filed Jun. 2, 2005 and U.S. provisional application No. 60/089,171 filed Jun. 10, 2005, the contents of which are fully incorporated herein by reference.

### FIELD OF THE INVENTION

The present invention relates to a blend comprising active comprising particles and inactive particles as means to control the activity strength of particulate materials. The present invention further relates to avoiding segregation in said blend.

### BACKGROUND OF THE INVENTION

In the production of granules comprising an active compound it is known in the art to coat inactive core particles with an active compound.

WO 2003/094899 relates to production of compositions for programmed release of enalapril. Inactive nuclei are prepared from sugar and starch. A binder solution is added to the nuclei where after a micronized enalapril maleate active drug is added thereto and subsequently covered with talc. One part of the granules are further coated, e.g., with ethyl cellulose. The coated and uncoated granules are mixed to form a desired release profile.

### SUMMARY OF THE INVENTION

One object of the present invention is to provide means for adjusting and controlling the activity strength of a composition of active comprising particles. Another object of the present invention is to provide means for avoiding segregation of the above mentioned mixture. A third object is to prepare inactive particles with same visual appearance as particles comprising an active compound.

The present invention provides thus in a first aspect a blend of particles comprising at least two different kinds of particles:

(a) particles comprising an active compound; and

(b) inactive particles comprising a coating.

The invention further provides methods for preparing said blend.

### DETAILED DESCRIPTION OF THE INVENTION

Definitions

The terms “particle” or “granule” are intended to be understood as predominantly spherical or near spherical structures of a macromolecular size.

The phrase “ratio between the diameter of the particle and the diameter of the core unit” (hereinafter abbreviated D_{P}/D_{C}) as used herein is to be understood as the diameter of the granule comprising a core unit and a shell unit divided by the diameter of the core unit only. If for example a core unit having a diameter of 100 micro-m is coated with a coating layer 200 micro-m thick, the granule would have a diameter of (200+100+200)=500 micro-m and D_{P}/D_{C} is 500 micro-m/100 micro-m=5.

The term “activity” when used in reference to an enzyme preparation or with reference to an enzyme particle or an enzyme core is a relative measure of the ability of the enzyme in the preparation, granule or core to react with a standard substrate at fixed standard conditions. Activity is measured in units which are defined as micromoles of substrate reacted per minute per gram of the measured sample at fixed standard conditions (herein after “a standard assay”). The activity is also a measure of the amount of active enzyme protein. An enzyme has a specific activity which is the activity of the pure enzyme protein in the standard assay. The specific activity is also measured in units which are defined as micromoles of substrate reacted per minute per gram of pure enzyme at fixed standard conditions. When the specific activity of an enzyme is known the amount of pure enzyme protein in a sample can be calculated. If a 1 gram sample of a pure enzyme reacts with 100 micromoles of a substrate per minute in a standard assay, the specific activity of the enzyme is 100 Units per gram pure enzyme. If a 1 gram sample of unknown enzyme activity reacts with 50 micromoles of a substrate per minute in the standard assay, the activity of the sample is 50 Units per gram and there is 0.5 g of pure enzyme protein in the sample.

The term “activity”, when used in reference to an enzyme or with reference to a granule, is to be understood as intending to mean the efficacy with which the enzyme or granule performs its intended task. With regard to an enzyme, this relates to its biocatalytic, such as metabolic, process. With regard to a granule, this relates to its overall intended task as designed in the overall formulation. The term “strength” relates to the activity of an enzyme or enzyme comprising particle in terms of its efficacy.

By particle size of the granule is meant the diameter obtained by measurements with sieves. When referring to a “particle size” it can either mean the diameter of one particle or the mean size of a batch of particles depending on the context.

The term “particle size ratio” is given by the particle size of the inactive particles divided by the particle size of the particles comprising an active compound and is hereinafter abbreviated D_{pI}/D_{pA}.

The term “particle size distribution” is meant to be understood as the range of sizes of granules resulting from a particular process; the spectrum or gradient distribution of particles with regards to their diameter.

The particle size distribution (PSD) can be expressed in terms of the mass mean diameter of the individual particles. A mean mass diameter of D50 is the diameter at which 50% of the granules, by mass, have a smaller diameter, while 50% by mass have a larger diameter. The values D10 and D90 are the diameters at which 10% and 90%, respectively, of the granules, by mass, have a smaller diameter than the value in question. The “span” indicates the breadth of the PSD and is expressed as:
(D90−D10)/D50.

The term “particle density ratio” is the particle density of the inactive particles divided by the density of the particles comprising active compounds and is hereinafter abbreviated:
ρ_{pI}/ρ_{pA}.

The term “segregation coefficient” is determined by a rolling bed test and is defined by Cs=|((activity in top section)−(activity in bottom section))|/|((activity in top section)+(activity in bottom section))|. The segregation coefficient is given in absolute values.

The segregation of the present invention is measured in a rolling bed according to the following method:

600 ml mixed particles are treated in a rolling bed. The rolling bed exists of a plastic cylinder, length 299 mm, width 89 mm. The cylinder is open at the top and placed in an inclination angle of 15°. In order to reduce static electricity, the cylinder is washed with Rodalon and dried. The cylinder is rotated by a motor with 45-55 rpm for 5 minutes. After rotation for 5 minutes the top half of the granules are removed from the cylinder. The average concentration of one kind of particle in both the top and bottom section is determined. The difference in concentration of the different particles between the top and the bottom section is a measure of the segregation potential of a particulate mixture. The method described here is similar to the one described by Williams J. C. and Khan M. I. (The Chemical Engineer, 19-25 Jan. 1973).

Another known method for measuring segregation is the heap tester.

The heap tester is a rectangular vessel with transparent walls. Its dimensions are: length 450 mm, diameter 38 mm and height 300 mm. Due to the narrow diameter it is also called a 2-dimensional heap. A funnel is placed in the center above the vessel. The funnel is filled with granular material and emptied into the vessel. The flow of material forms a so-called 2-dimensional heap with its top at the center of the vessel. The heap is divided into sections or compartments with slicers. The slicers are pushed down into the heap and physically separate the slope into equally spaced sections along the flow direction of the granules. Samples are taken from the top of each section with a suction system. The concentration of one component in each section is determined. The difference in concentration between the center and sides of the heap is a measure of the segregation potential of a granular mixture.

Introduction

Compositions comprising a specific active compound can normally be obtained in a variety of activity strengths depending on the application the composition has to be applied to. To produce particles with a variety of different activity strengths for one specific active compound requires that a new batch is produced for each different activity strength needed, which is costly and time consuming. Furthermore large storage facilities are needed for all of the different activity strength particles to be on stock.

In the pursuit of overcoming these issues, we have found that by adding inactive particles to active comprising particles we are able of getting compositions with any desired activity strength; thereby decreasing the number of granulates with different activities to be prepared and only having to prepare particles with one or few specific activities. It is therefore a desire to be able to produce particles comprising active compounds which have a significant activity and then using the inactive particles to dilute the composition to obtain the desired activity strength of the batch.

Another way of overcoming these issues is to produce high strength particles and low strength particles and use the low strength particles to dilute the high strength particles to any desired activity strength.

The use of simple non-coated inactive cores in a batch of active compound containing particles to adjust the activity strength of a batch has, however, shown several negative aspects. One problem occurring when adding simple inactive cores, e.g., salt particles to active compound containing particles is segregation of the simple inactive cores and the active compound containing particles, due to difference in density and size, another problem is that the simple inactive cores are visual in the batch. The solution to these negative aspects and to the use of simple inactive cores is to prepare inactive particles either matching the appearance of active compound containing particles or otherwise altering particle density and/or size distribution and/or surface properties (sphericity, roughness etc) in order to prevent segregation. The main parameters which are used in the present invention to prevent segregation are adjustment of particle size and particle density. One way of avoiding segregation is to prepare inactive particles with more or less equivalent density and particle size as the particles comprising active compounds.

If the density of the inactive particles results in segregation as it either is too high or too low, segregation can be prevented by adjusting the particle size of the particles. If the density of the inactive particles is higher than the particle density of the active containing particles resulting in segregation the particle size of the inactive particles has to be increased to level out segregation. If the density of the inactive particles is lower than the density of the active containing particles resulting in segregation, the size of the active comprising particles has to be increased to avoid segregation. The density of the materials used to change the particle sizes is also important.

The blend of the invention is preferably a premix or intermediary product to be used in an industrial process to prepare a final product.

In a particular embodiment of the present invention the blend of the invention is on powder form.

The Particles of the Invention

One object of the present invention is to prevent segregation.

Segregation of particles is mainly a problem of particles with a particle size above 50 micro-m. The particles of the invention have in a particular embodiment a particle size of at least 50 micro-m. In a more particular embodiment the particle size is at least 100 micro-m. In a most particular embodiment the particle size is at least 200 micro-m. In a particular embodiment of the present invention the particle sizes are between 100 micro-m to 2500 micro-m. In a more particular embodiment of the present invention the particle size is between 200 micro-m to 1200 micro-m. In an even more particular embodiment the particle size is between 250 micro-m to 850 micro-m. In a most particular embodiment the particle size is between 450 micro-m to 650 micro-m.

If the surface characteristics, roughness, sphericity, etc. of the inactive and active particles is about equal, the main parameters affecting segregation are particle size and particle density.

If the particle densities are not equal, segregation may be minimized by shifting the size distribution towards larger or smaller size. A larger particle size will compensate for higher density and vice versa.

For purposes of the present invention, the particle size distribution is normally as narrow as possible. The span of the particles according to the invention is therefore typically not more than about 2.5, preferably not more than about 2.0, more preferably not more than about 1.5, and most preferably not more than about 1.0 or even not more than 0.5. In a particular embodiment the span of the particles are between 0.1 and 0.9. One way of obtaining a narrow particle size distribution of the blend of particles is to coat the inactive particles so as to obtain a particle size distribution of the inactive particles approximating the particle size distribution of the active particles.

One way of avoiding segregation may be to adjust the density of the inactive particles to match the active compound containing particles. Another way of avoiding segregation may be to increase or decrease the density of the inactive particles depending on the particle size of the active compound containing particles and the inactive particles. If a size difference between the active and inactive particles is unwanted, the particle densities must be about equal to avoid segregation. In a particular embodiment of the present invention the difference in density of the inactive particles and the active particles is less than 1.5 g/ml, such as less than 1 g/ml, even less than 0.5 g/ml. In a particular embodiment the difference in density of the inactive particles and the active particles is less than 0.25 g/ml. In a more particular embodiment of the present invention the difference in density of the inactive particles and the active particles is less than 0.1 g/ml.

The particle size ratio of the inactive particles and the active comprising particles, D_{pI}/D_{pA}, is in a particular embodiment of the present invention between 0.5 and 2 such as between 0.6 and 1.4. In a more particular embodiment of the present invention the particle size ratio is between 0.7 and 1.3. In an even more particular embodiment of the present invention the particle size ratio is between 0.8 and 1.2. In an even further embodiment the particle size ratio is between 0.9 and 1.1. In a most particular embodiment of the present invention the particle size is between 0.95 and 1.05.

It has been found that it is possible to reduce segregation of a blend where the particles significantly differ either in particle size and/or density by carefully designing the particle size or the density such that lighter particles have a larger diameter and vice versa. It has been found that with regard to segregation the diameter and the density are approximately of equal importance, i.e., to minimize the segregation the ratio ρ_{pI}/ρ_{pA} should be close to D_{pI}/D_{pA}. To obtain a low segregation the densities and diameters should be selected to fit 0.9<(ρ_{pI}/ρ_{pA})·(D_{pA}/D_{pI})<1.1, preferably 0.95<(ρ_{pI}/ρ_{pA})·(D_{pA}/D_{pI})<1.05. It has been found that even if ρ_{pI}/ρ_{pA} or D_{pA}/D_{pI} is higher than or equal to 1.1 or lower than or equal to 0.9, or even higher than or equal to 1.2 or lower than or equal to 0.8, this formula can be used to optimize the corresponding either particle size or density to minimize segregation by means of the coating technologies described. This compensation can reduce the segregation coefficient to lower than 0.3. In a particular embodiment (ρ_{pI}/ρ_{pA})·(D_{pA}/D_{pI}) is between 0.9 and 1.1. In a more particular embodiment (ρ_{pI}/ρ_{pA})·(D_{pA}/D_{pI}) is between 0.95 and 1.05.

In a particular embodiment of the present invention the segregation coefficient is less than 0.3. In a more particular embodiment of the present invention the segregation coefficient is less than 0.2. In an even more particular embodiment the segregation coefficient is less than 0.15. In an even further embodiment the segregation coefficient is less than 0.1. In a most particular embodiment the segregation coefficient is less than 0.08 even less than 0.06 such as less than 0.05. The segregation coefficient is determined by a rolling bed test.

Applying thick fluid bed coatings onto a small core particle will provide a combination of possibilities for adjusting the particle density since both the core density and the coating density can be varied. Variation of coating density can be obtained by applying materials with different densities or by changing process conditions giving different porosity of the coating, e.g., by spraying a solution or a suspension onto a core where a suspension typically will give higher porosity of the layer applied than a solution when applied onto a core.

In a particular embodiment of the present invention the average particle density is between 0.3 to 3.0 g/ml. In a more particular embodiment of the present invention the average particle density is between 0.8 to 2.5 g/ml. In an even more particular embodiment of the present invention the average particle density is between 1.5 g/ml to 2.1 g/ml.

The particle density ratio of the inactive particles and the active comprising particles is in a particular embodiment of the present invention between 0.5 and 2. In a more particular embodiment of the present invention the particle density ratio is between 0.6 and 1.4. In an even more particular embodiment of the present invention the particle density ratio is between 0.7 and 1.3. In an even further embodiment the particle density ratio is between 0.8 and 1.2. In an even further particular embodiment of the present invention the particle density ratio is between 0.9 and 1.1. In a most particular embodiment of the present invention the particle density ratio is between 1.05 and 0.95.

The particle density is measured by the pycnometer method which is well known in the art. A 150 ml volumetric flask is used and 20-70 g samples are tested. The flask is filled to the line with nonionic surfactant (linear secondary alcohol ethoxylate, 12-14 alkyl carbons, 4.5-5.5 mole EO, viscosity at 25° C. of 25-40 cPs, surface tension 26-30 dyne/cm, HLB 9-12, specific gravity at 20° C. of 0.93-0.99 g/ml, e.g., Softanol 50 from Ineos Oxide) and the particle density is calculated from the measured volume of the flask, the weight of the flask filled with only nonionic surfactant (density of the surfactant), the weight of the sample and the weight of the flask with sample and nonionic surfactant.

Visual Appearance

It may be very important that a batch of particles has a homogeneous appearance which often is a requirement from customers. It may be of importance that the particles resemble the particles they are mixed with in composition, e.g., detergent particles. However in some cases it may be better to be able to visually distinguish between active and inactive particles, this would provide a quick insight in how well mixed there are.

To be able to give a measure for appearance the Hunter Lab color analysis method may be used where delta values ΔL, Δa, Δb and ΔE are used. These values indicate how much a standard and a sample differs in color from one another.

The total difference in colour is given by ΔE.
ΔE=\sqrt{Δa²+Δb²+ΔL²}

The color difference should be as low as possible which means that ΔE should be as low as possible.

In a particular embodiment of the present invention the color difference ΔE between the inactive particles and the particles comprising active compounds is less than 6. In a more particular embodiment of the present invention the color difference ΔE between the inactive particles and the particles comprising active compounds is less than 5. In an even more particular embodiment of the present invention the color difference ΔE between the inactive particles and the particles comprising active compounds is less than 4. In a most particular embodiment of the present invention the color difference ΔE between the inactive particles and the particles comprising active compounds is less than 3.

Materials

The particles of the invention may comprise but are not limited to one or more of the following components:
binders, polysaccharides, synthetic polymers, waxes, fillers, fiber materials, enzyme stabilizing agents, solubilizing agents, cross-linking agents, suspension agents, viscosity regulating agents, light spheres, plasticizers, pigments, salts and lubricants.

The particles of the invention are preferably spherical or near spherical.

Polysaccharides

The polysaccharides of the present invention may be un-modified naturally occurring polysaccharides or modified polysaccharides.

Suitable polysaccharides include cellulose, pectin, dextrin and starch. The starches may be soluble or insoluble in water.

In a particular embodiment of the present invention the polysaccharide is a starch. In a particular embodiment of the present invention the polysaccharide is an insoluble starch.

Naturally occurring starches from a wide variety of plant sources are suitable in the context of the invention (either as starches per se, or as the starting point for modified starches), and relevant starches include starch from: rice, corn, wheat, potato, oat, cassava, sago-palm, yuca, barley, sweet potato, sorghum, yams, rye, millet, buckwheat, arrowroot, taro, tannia, and may for example be in the form of flour.

Cassava starch is among preferred starches in the context of the invention; in this connection it may be mentioned that cassava and cassava starch are known under various synonyms, including tapioca, manioc, mandioca and manihot.

As employed in the context of the present invention, the term “modified starch” denotes a naturally occurring starch, which has undergone some kind of at least partial chemical modification, enzymatic modification, and/or physical or physicochemical modification, and which—in general—exhibits altered properties relative to the “parent” starch.

In a particular embodiment of the present invention the granule comprise a polysaccharide.

Synthetic Polymers

By synthetic polymers is meant polymers which backbone has been polymerized synthetically.

Suitable synthetic polymers of the invention includes in particular polyvinyl pyrrolidone (PVP), polyvinyl alcohol (PVA), polyvinyl acetate, polyacrylate, polymethacrylate, polyacrylamide, polysulfonate, polycarboxylate, and copolymers thereof, in particular water soluble polymers or copolymers.

In a particular embodiment of the present invention the synthetic polymer is a vinyl polymer.

Waxes

A “wax” in the context of the present invention is to be understood as a polymeric material having a melting point between 25 and 150° C., particularly 30 to 100° C. more particularly 35 to 85° C. most particularly 40 to 75° C. The wax is preferably in a solid state at room temperature, 25° C. The lower limit is preferred to set a reasonable distance between the temperature at which the wax starts to melt to the temperature at which the granules or compositions comprising the granules are usually stored, 20 to 30° C.

A “wax composition” in this context is to be understood as mixture comprising two or more waxes. Such compositions usually have a melting range rather than a melting point. The temperature at which the wax composition start to melt is called T_{m,i}, and the median melting point for the wax composition is called T_{m,m}, while the temperature at which all wax solids are melted is called T_{m,e}. The median melting point in this context is defined as the temperature at which 50% w/w of the solids in the wax are melted.

In a particular embodiment of the present invention the T_{m,i} of the wax composition is more than 25° C. In a more particular embodiment of the present invention the T_{m,i} of the wax composition is more than 30° C. In a most particular embodiment of the present invention the T_{m,i} of the wax composition is more than 35° C.

The melting range is calculated as the difference in degrees Celsius between the temperature at which all wax solids are melted (T_{m,e}) and the temperature at which the wax composition starts to melt (T_{m,i}).

For some granules, e.g., granules used in the detergent industry, a preferable feature of the wax is that the wax should be water soluble or water dispersible, particularly in neutral and alkaline solution, so that when the coated particles of the invention is introduced into an aqueous solution, i.e., by diluting it with water, the wax should disintegrate and/or dissolve providing a quick release and dissolution of the active incorporated in the particles to the aqueous solution. Examples of water soluble waxes are poly ethylene glycols (PEG's). Amongst water insoluble waxes, which are dispersible in an aqueous solution are triglycerides and oils. For some granules it is preferable that the coating contains some insoluble waxes, e.g., feed granules.

Preferably the wax composition is a hydrophilic composition. In a particular embodiment at least 25% w/w of the constituents comprised in the wax composition is soluble in water, preferably at least 50% w/w, preferably at least 75% w/w, preferably at least 85% w/w, preferably at least 95% w/w, preferably at least 99% w/w.

In another embodiment the wax composition is hydrophilic and dispersible in an aqueous solution.

In a particular embodiment the wax composition comprise less than 75% w/w hydrophobic constituents, preferably less than 50% w/w, preferably less than 25% w/w, preferably less than 15% w/w, preferably less than 5% w/w, preferably less than 1 % w/w.

In a particular embodiment the wax composition comprise less than 75% w/w water insoluble constituents, preferably less than 50% w/w, preferably less than 25% w/w, preferably less than 15% w/w, preferably less than 5% w/w, preferably less than 1 % w/w.

Suitable waxes are organic compounds or salts of organic compounds having one or more of the above mentioned properties.

The wax composition may preferably constitute at least 10% by weight of the coating material, more preferably at least 20% by weight of the coating material.

The wax composition of the invention may comprise any wax, which is chemically synthesized. It may also equally well comprise waxes isolated from a natural source or a derivative thereof. Accordingly, the wax composition of the invention may comprise waxes selected from the following non limiting list of waxes.

Poly ethylene glycols, PEG. Different PEG waxes are commercially available having different molecular sizes, wherein PEG's with low molecular sizes also have low melting points. Examples of suitable PEG's are PEG 1500, PEG 2000, PEG 3000, PEG 4000, PEG 6000, PEG 8000, PEG 9000, etc., e.g., from BASF (Pluriol E series) or from Clariant or from Ineos. Derivatives of Poly ethylene glycols may also be used.

Polypropylenes (e.g., polypropylene glycol Pluriol P series from BASF) or polyethylenes or mixtures thereof. Derivatives of polypropylenes and polyethylenes may also be used.

Nonionic surfactants which are solid at room temperature such as ethoxylated fatty alcohols having a high level of ethoxy groups such as the Lutensol AT series from BASF, a C16-C18 fatty alcohol having different amounts of ethyleneoxide per molecule, e.g., Lutensol AT11, AT13, AT25, AT50, AT80, where the number indicate the average number of ethyleneoxide groups. Alternatively polymers of ethyleneoxide, propyleneoxide or copolymers thereof are useful, such as in block polymers, e.g., Pluronic PE 6800 from BASF. Derivatives of ethoxylated fatty alcohols.

Waxes isolated from a natural source, such as Carnauba wax (melting point between 80-88° C.), Candelilla wax (melting point between 68-70° C.) and bees wax. Other natural waxes or derivatives thereof are waxes derived from animals or plants, e.g., of marine origin. Hydrogenated plant oil or animal tallow. Examples of such waxes are hydrogenated ox tallow, hydrogenated palm oil, hydrogenated cotton seeds and/or hydrogenated soy bean oil, wherein the term “hydrogenated” as used herein is to be construed as saturation of unsaturated carbohydrate chains, e.g., in triglycerides, wherein carbon=carbon double bonds are converted to carbon-carbon single bonds. Hydrogenated palm oil is commercially available, e.g., from Hobum Oele und Fette GmbH—Germany or Deutche Cargill GmbH—Germany.

Fatty acid alcohols, such as the linear long chain fatty acid alcohol NAFOL 1822 (C18, 20, 22) from Condea Chemie GMBH—Germany, having a melting point between 55-60° C. Derivatives of fatty acid alcohols.

Monoglycerides and/or diglycerides, such as glyceryl stearate, wherein stearate is a mixture of stearic and palmitic acid, are useful waxes. An example of this is Dimodan PM—from Danisco Ingredients, Denmark.

Fatty acids, such as hydrogenated linear long chained fatty acids and derivatives of fatty acids.

Paraffines, i.e., solid hydrocarbons.

Micro-crystalline wax.

In further embodiments waxes which are useful in the invention can be found in C. M. McTaggart et al., Int. J. Pharm. 19, 139 (1984) or Flanders et al., Drug Dev. Ind. Pharm. 13, 1001 (1987) both incorporated herein by reference.

In a particular embodiment of the present invention the wax of the present invention is a mixture of two or more different waxes.

In a particular embodiment of the present invention the wax or waxes is selected from the group consisting of PEG, ethoxylated fatty alcohols, fatty acids, fatty acid alcohols and glycerides.

In another particular embodiment of the present invention the waxes are chosen from synthetic waxes. In a more particular embodiment the waxes of the present invention are PEG or nonionic surfactants. In a most particular embodiment of the present invention the wax is PEG.

Fillers

Suitable fillers are water soluble and/or insoluble inorganic salts such as finely ground alkali sulphate, alkali carbonate and/or alkali chloride, clays such as kaolin (e.g., SPESWHITE™, English China Clay), bentonites, talcs, zeolites, chalk, calcium carbonate and/or silicates.

Fiber materials

Pure or impure cellulose in fibrous form such as sawdust, pure fibrous cellulose, cotton, or other forms of pure or impure fibrous cellulose. Also, filter aids based on fibrous cellulose can be used. Several brands of cellulose in fibrous form are on the market, e.g., CEPO™ and ARBOCELL™. Pertinent examples of fibrous cellulose filter aids are ARBOCELL BFC 200™ and ARBOCELL BC 200™. Also synthetic fibers may be used as described in EP 304331 B1 and typical fibers may be made of polyethylene, polypropylene, polyester, especially nylon, polyvinylformate, poly(meth)acrylic compounds.

Enzyme Stabilizing Agents

Enzyme stabilizing or protective agents such as conventionally used in the field of granulation may be elements of the core or the coating. Stabilizing or protective agents may fall into several categories: alkaline or neutral materials, reducing agents, antioxidants and/or salts of first transition series metal ions. Each of these may be used in conjunction with other protective agents of the same or different categories. Examples of alkaline protective agents are alkali metal silicates, carbonates or bicarbonates, which provide a chemical scavenging effect by actively neutralizing, e.g., oxidants. Examples of reducing protective agents are salts of sulfite, thiosulfite, thiosulfate or MnSO₄ while examples of antioxidants are methionine, butylated hydroxytoluene (BHT) or butylated hydroxyanisol (BHA). In particular stabilising agents may be salts of thiosulfates, e.g., sodium thiosulfate or methionine. Also enzyme stabilizers may be borates, borax, formates, di- and tricarboxylic acids and reversible enzyme inhibitors such as organic compounds with sulfhydryl groups or alkylated or arylated boric acids. Examples of boron based stabilizer may be found in WO 96/21716, whereas a preferred boron based stabilizer is 4-formyl-phenyl-boronic acid or derivatives thereof described in WO 96/41859 both disclosures incorporated herein by reference. Still other examples of useful enzyme stabilizers are gelatine, casein, polyvinyl pyrrolidone (PVP) and powder of skimmed milk. The amounts of protective agent in the coating may be 5-40% w/w of the coating, particularly 5-30%, e.g., 10-20%.

Solubilizing Agents

The solubility of the coating is especially critical in cases where the coated particle is a component of a detergent formulation. As is known by the person skilled in the art, many agents, through a variety of methods, serve to increase the solubility of formulations, and typical agents known to the art can be found in National Pharmacopeia's.

Light Spheres

Light spheres are small particles with low true density. Typically, they are hollow spherical particles with air or gas inside. Such materials are usually prepared by expanding a solid material. These light spheres may be inorganic of nature such as SCOTCHLITE™ Glass Bubbles from 3M™ (hollow glass spheres), Q-CEL® (hollow microspheres of borosilicate glass) and/or Extendospheres® (ceramic hollow spheres) available from The PQ Corporation. The light spheres may also be of organic nature such as the PM-series (plastic hollow spheres) available from The PQ Corporation. Expancel® (hollow plastic spheres) from AKZO Nobel, Luxsil® and Sphericel® from Potters Industries and/or Styrocell® from SHELL, which is spheres of polystyrene. The polystyrene of Styrocell® contains pentane which upon heating boils and expands or pops the material (the reaction is comparable to the expansion of corn seeds into popcorn) leaving a light polystyrene material of a low true density. Also polysaccharides are preferred, such as starch or derivatives thereof. Biodac® is an example of non-hollow lightweight material made from cellulose (waste from papermaking), available from GranTek Inc. These materials may be included in the granules of the invention either alone or as a mixture of different light materials.

Cross-linking Agents

Cross-linking agents such as enzyme-compatible surfactants, e.g., ethoxylated alcohols, especially ones with 10 to 80 ethoxy groups. These may both be found in the coating and in the core particle.

Suspension Agents

Suspension agents, mediators (for boosting bleach action upon dissolution of the particle in, e.g., a washing application) and/or solvents may be incorporated in the particles.

Viscosity Regulating Agents

Viscosity regulating agents may be present in the particles.

Plasticizers

Plasticizers useful in coating layers in the context of the present invention include, for example: polyols such as sugars, sugar alcohols, glycerine, glycerol trimethylol propane, neopentyl glycol, triethanolamine, mono-, di- and triethylene glycol or polyethylene glycols (PEGS) having a molecular weight less than 1000; urea, phthalate esters such as dibutyl or dimethyl phthalate; thiocyanates, non-ionic surfactants such as ethoxylated alcohols and ethoxylated phosphates and water.

Pigments

Suitable pigments include, but are not limited to, finely divided whiteners, such as titanium dioxide or kaolin, colored pigments, water soluble colorants, as well as combinations of one or more pigments and water soluble colorants. In case where the granules are comprising enzymes and the granules are additives for detergents, a whitening agent, e.g., TiO₂ can be incorporated in the granules. By adding the TiO₂ at different times during the granulation process, if the granulation is performed discontinuously, at different positions in the in the granulator, or if the granulation is performed continuously, the TiO₂ may be distributed inside the wax coating or on the surface of the wax coating or both if desired.

Salt

The salt may be an inorganic salt, e.g., salts of sulfate, sulfite, phosphate, phosphonate, nitrate, chloride or carbonate or salts of simple organic acids (less than 10 carbon atoms, e.g., 6 or less carbon atoms) such as citrate, malonate or acetate. Examples of cations in these salt are alkali or earth alkali metal ions, although the ammonium ion or metal ions of the first transition series, such as sodium, potassium, magnesium, calcium, zinc or aluminium. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate or gluconate. In particular alkali- or earth alkali metal salts of sulfate, sulfite, phosphate, phosphonate, nitrate, chloride or carbonate or salts of simple organic acids such as citrate, malonate or acetate may be used. Specific examples include NaH₂PO₄, Na₂HPO₄, Na₃PO₄, (NH₄)H₂PO₄, K₂HPO₄, KH₂PO₄, Na₂SO₄, K₂SO₄, KHSO₄, ZnSO₄, MgSO₄, CuSO₄, Mg(NO₃)₂, (NH₄)₂SO₄, sodium borate, magnesium acetate and sodium citrate.

The salt may also be a hydrated salt, i.e., a crystalline salt hydrate with bound water(s) of crystallization, such as described in WO 99/32595. Examples of hydrated salts include magnesium sulfate heptahydrate (MgSO₄(7H₂O)), zinc sulfate heptahydrate (ZnSO₄(7H₂O)), copper sulfate pentahydrate (CuSO₄(5H₂O)), sodium phosphate dibasic heptahydrate (Na₂HPO₄(7H₂O)), magnesium nitrate hexahydrate (Mg(NO₃)₂(6H₂O)), sodium borate decahydrate, sodium citrate dihydrate and magnesium acetate tetrahydrate.

Lubricant

As used in the present context, the term “lubricant” refers to any agent, which reduces surface friction, lubricates the surface of the granule, decreases tendency to build-up of static electricity, and/or reduces friability of the granules. Lubricants can also play a related role in improving the coating process, by reducing the tackiness of binders in the coating. Thus, lubricants can serve as anti-agglomeration agents and wetting agents. Examples of suitable lubricants are lower polyethylene glycols (PEGs), ethoxylated fatty alcohols and mineral oils. The lubricant is particularly a mineral oil or a nonionic surfactant, and more particularly the lubricant is not miscible with the other coating materials.

Inactive Particles

The construction of the inactive particles may be a homogeneous mixture throughout the particle or it may be a layered particle. In a particular embodiment of the present invention the inactive particle comprise an inactive core particle upon which at least one coating is applied.

Inactive Core Particles

Inactive core particles such as placebo particles, carrier particles, inactive nuclei, inert particles, non-pareil particles, non active particles or seeds are particles not comprising active compounds upon which a coating mixture comprising the active compound can be layered. They may be formulated with organic or inorganic materials such as inorganic salts, sugars, sugar alcohols, small organic molecules such as organic acids or salts, starch, cellulose, polysaccharides, minerals such as clays or silicates or a combination of two or more of these.

In a particular embodiment of the present invention the particles to be coated are inactive particles. In a more particular embodiment of the present invention the material of the core particles are selected from the group consisting of inorganic salts, sugar alcohols, small organic molecules, starch, cellulose and minerals. In a particular embodiment of the present invention the particles are not made of alkali metal silicates.

The core particles have in a particular embodiment of the present invention a particle size of at least 50 micro-m. In a more particular embodiment the core particle size is at least 100 micro-m. In a most particular embodiment the core particle size is at least 150 micro-m. In a particular embodiment of the present invention the core particle sizes are between 50 micro-m to 1200 micro-m. In a more particular embodiment of the present invention the core particle size is between 100 micro-m to 800 micro-m. In an even more particular embodiment the core particle size is between 125 micro-m to 450 micro-m. In a most particular embodiment the core particle size is between 150 micro-m to 350 micro-m or even 200 micro-m to 300 micro-m.

Coatings

The coating or coatings applied to the inactive core particles are used to obtain the desired feature of the inactive particle being, e.g., a specific density or a specific size or size distribution. The coating may further be used to obtain the same or similar appearance as the particles comprising active compounds.

The coating applied to the inactive core particles may be but are not limited to any coating known from pharmaceutical and enzymatic products.

The coating may comprise one or more conventional shell or coating components such as described in WO 89/08694, WO 89/08695, 270 608 B1 and/or WO 00/01793. Other examples of conventional coating materials may be found in U.S. Pat. No. 4,106,991, EP 170360, EP 304332, EP 304331, EP 458849, EP 458845, WO 97/39116, WO 92/12645A, WO 89/08695, WO 89/08694, WO 87/07292, WO 91/06638, WO 92/13030, WO 93/07260, WO 93/07263, WO 96/38527, WO 96/16151, WO 97/23606, U.S. Pat. No. 5,324,649, U.S. Pat. No. 4,689,297, EP 206417, EP 193829, DE 4344215, DE 4322229 A, DD 263790, JP 61162185 A and/or JP 58179492. In a particular embodiment the coating is not an organo diphosphonate.

For some inactive core particles it is difficult to obtain the desired features of the particle simply by encapsulating the inactive core particles with a thin coating, hence it is desirable to apply several coatings or a thick coating such as coatings known from WO 01/25412 hereby incorporated by reference.

In a particular embodiment of the present invention the inactive granule of the invention has a structure wherein D_{P}/D_{C} is at least 1.1, which means that the thickness of the shell unit is at least 5% of the core unit diameter. In a particular embodiment D_{P}/D_{C} for the granule is at least 1.05, more particularly at least 1.25, more particularly at least 1.5, even more particularly at least 2, most particularly at least 3. D_{P}/D_{C} is however particularly below about 100, particularly below about 50, more particularly below 25, and most particularly below 10.

To obtain the same or similar appearance as the particles comprising an active compound it may be necessary to apply coatings with a minimum thickness, to ensure the right surface appearance.

In a particular embodiment of the present invention the coating is at least 10 micro-m thick. In a more particular embodiment the thickness is at least 25 micro-m such as at least 50 micro-m, at least 75 micro-m, at least 100 micro-m, at least 150 micro-m, at least 200 micro-m or most particularly at least 300 micro-m.

In a particular embodiment of the present invention the coating constitutes at least 5% of the total granule by weight In a more particular embodiment of the present invention the coating constitutes at least 10% by weight of the total granule. In an even more particular embodiment the coating constitutes at least 25% by weight, even such as 50% by weight. In an even further embodiment the coating constitutes at least 75% by weight of the total granule. In a most particular embodiment of the present invention the coating constitutes at least 90% by weight of the total granule even such as 95% by weight of the total granule.

In a particular embodiment of the present invention the coating constitutes at least 5% of the total granule by volume In a more particular embodiment of the present invention the coating constitutes at least 10% by volume of the total granule. In an even more particular embodiment the coating constitutes at least 25% by volume, even such as 50% by volume. In an even further embodiment the coating constitutes at least 75% by volume of the total granule. In a most particular embodiment of the present invention the coating constitutes at least 90% by volume of the total granule even such as 95% by volume of the total granule.

The density of inert core particles is usually higher than the density of particles comprising active compounds. Therefore it is often a benefit that the coatings used to alter the size and the density of the inactive particles has a lower density than the density of the inert core particles to be able to obtain the desired effect.

In a particular embodiment of the present invention the difference between the density of the coating and the core of the particles is at least 5%. In a more particular embodiment of the present invention the difference between the density of the coating and the core of the particles is at least 10%. In an even more particular embodiment the difference between the density of the coating and the core of the particles is at least 25%. In a most particular embodiment the difference between the density of the coating and the core of the particles is at least 50%.

In a particular embodiment of the present invention the density of the coating is at least 5% lower than the density of the core. In a more particular embodiment of the present invention the density of the coating is at least 10% lower than the density of the core. In an even more particular embodiment of the present invention the density of the coating is at least 25% lower than the density of the core. In a most particular embodiment of the present invention the density of the coating is at least 50% lower than the density of the core.

The particle density of the coated particle pp is given from the particle density of the core ρ_{C} and the coating ρ_{coating} and the diameters:
ρ_{P}=(ρ_{C}·D_{C}³+ρ_{coating}·(D_{P}³−D_{C}³))/D_{P}³

In practice the particle density and particle size of the coated particle are measured, as well as the core density and size. The coating density can be calculated using the formula above.

Granules Comprising an Active Compound

The granules comprising active compounds may be any granule formulated to comprise an active compound.

One object of the present invention is to provide a way of obtaining any desired activity strength of a granulate comprising active compounds in an easy way. The idea is to produce a high strength granule (a granule with a high activity) and mix it together with a granule that has either no activity or low activity compared to the high activity granule, such as to provide a method for diluting the high strength granules to any desired activity strength.

In a particular embodiment of the present invention the activity strength of the high activity granule is at least 4 times higher than the activity of the low activity granule.

In a more particular embodiment of the present invention the activity strength of the high activity granule is at least 10 times higher than the activity of the low activity granule.

In a most particular embodiment of the present invention the activity strength of the high activity granule is at least 100 times higher than the activity of the low activity granule.

If a low activity granule is used to dilute the high activity granules instead of inactive granules, everything related to the inactive granule disclosed in this description does also apply to the low activity granule.

Active Compounds

The active compound of the present invention either present in the core or in the coating may be any active compound or mixture of active compounds, which benefits from being separated from the environment surrounding the granule. The term “active” is meant to encompass all compounds, which upon release from the coated particle upon applying the coated particle of the invention in a process, serve a purpose of improving the process. The active compound may be inorganic of nature or organic of nature. Particularly active compounds are active biological compounds which are usually very sensitive to the surrounding environment such as compounds obtainable from microorganisms. More particularly active compounds are peptides or polypeptides or proteins. Most particularly active compounds are proteins such as enzymes. Further suitable active compounds are bleaches, growth promoters, antibiotics, antigenic determinants to be used as vaccines, polypeptides engineered to have an increased content of essential amino acids, hormones and other therapeutic proteins. In a particular embodiment of the present invention the active compounds are proteins. In a more particular embodiment the proteins are enzymes.

The enzyme in the context of the present invention may be any enzyme or combination of different enzymes. Accordingly, when reference is made to an “enzyme” this will in general be understood to include one enzyme or a combination of enzymes.

It is to be understood that enzyme variants (produced, for example, by recombinant techniques) are included within the meaning of the term “enzyme”. Examples of such enzyme variants are disclosed in, e.g., EP 251,446 (Genencor), WO 91/00345 (Novo Nordisk), EP 525,610 (Solvay) and WO 94/02618 (Gist-Brocades NV).

Enzymes can be classified on the basis of the handbook Enzyme Nomenclature from NC-IUBMB, 1992), see also the ENZYME site at the internet: www.expasv.ch/enzyme/. ENZYME is a repository of information relative to the nomenclature of enzymes. It is primarily based on the recommendations of the Nomenclature Committee of the International Union of Biochemistry and Molecular Biology (IUB-MB), Academic Press, Inc., 1992, and it describes each type of characterized enzyme for which an EC (Enzyme Commission) number has been provided (Bairoch A. The ENZYME database, 2000, Nucleic Acids Res 28:304-305). This IUB-MB Enzyme nomenclature is based on their substrate specificity and occasionally on their molecular mechanism; such a classification does not reflect the structural features of these enzymes.

Another classification of certain glycoside hydrolase enzymes, such as endoglucanase, xylanase, galactanase, mannanase, dextranase and alpha-galactosidase, in families based on amino acid sequence similarities has been proposed a few years ago. They currently fall into 90 different families: See the CAZy(ModO) internet site (Coutinho, P. M. & Henrissat, B. (1999) Carbohydrate-Active Enzymes server at URL: afmb.cnrs-mrs.fr/˜cazy/CAZY/index.html (corresponding papers: Coutinho, P. M. & Henrissat, B. (1999) Carbohydrate-active enzymes: an integrated database approach. In “Recent Advances in Carbohydrate Bioengineering”, H. J. Gilbert, G. Davies, B. Henrissat and B. Svensson eds., The Royal Society of Chemistry, Cambridge, pp. 3-12; Coutinho, P. M. & Henrissat, B. (1999), The modular structure of cellulases and other carbohydrate-active enzymes: an integrated database approach. In “Genetics, Biochemistry and Ecology of Cellulose Degradation”, K. Ohmiya, K. Hayashi, K. Sakka, Y. Kobayashi, S. Karita and T. Kimura eds., Uni Publishers Co., Tokyo, pp. 15-23).

The types of enzymes which may be incorporated in particles of the invention include oxidoreductases (EC 1.-.-.-) transferases (EC 2.-.-.-), hydrolases (EC 3.-.-.-), lyases (EC 4.-.-.-), isomerases (EC 5.-.-.-) and ligases (EC 6.-.-.-).

Preferred oxidoreductases in the context of the invention are peroxidases (EC 1.11.1), laccases (EC 1.10.3.2) and glucose oxidases (EC 1.1.3.4). An example of a commercially available oxidoreductase (EC 1.-.-.-) is Gluzyme™ (enzyme available from Novozymes A/S). Further oxidoreductases are available from other suppliers. Preferred transferases are transferases in any of the following sub-classes:
a. Transferases transferring one-carbon groups (EC 2.1);
b. transferases transferring aldehyde or ketone residues (EC 2.2); acyltransferases (EC 2.3);
c. glycosyltransferases (EC 2.4);
d. transferases transferring alkyl or aryl groups, other that methyl groups (EC 2.5); and
e. transferases transferring nitrogeneous groups (EC 2.6).

A most preferred type of transferase in the context of the invention is a transglutaminase (protein-glutamine gamma-glutamyltransferase; EC 2.3.2.13).

Further examples of suitable transglutaminases are described in WO 96/06931 (Novo Nordisk A/S).

Preferred hydrolases in the context of the invention are: carboxylic ester hydrolases (EC 3.1.1.-) such as lipases (EC 3.1.1.3); phytases (EC 3.1.3.-), e.g., 3-phytases (EC 3.1.3.8) and 6-phytases (EC 3.1.3.26); glycosidases (EC 3.2, which fall within a group denoted herein as “carbohydrases”), such as alpha-amylases (EC 3.2.1.1); peptidases (EC 3.4, also known as proteases); and other carbonyl hydrolases. Examples of commercially available phytases include Bio-Feed™ Phytase (Novozymes), Ronozyme™ (DSM Nutritional Products), Natuphos™ (BASF), Finase™ (AB Enzymes), and the Phyzyme™ product series (Danisco). Other preferred phytases include those described in WO 98/28408, WO 00/43503, and WO 03/066847.

In the present context, the term “carbohydrase” is used to denote not only enzymes capable of breaking down carbohydrate chains (e.g., starches or cellulose) of especially five- and six-membered ring structures (i.e., glycosidases, EC 3.2), but also enzymes capable of isomerizing carbohydrates, e.g., six-membered ring structures such as D-glucose to five-membered ring structures such as D-fructose.

Carbohydrases of relevance include the following (EC numbers in parentheses): Alpha-amylases (EC 3.2.1.1), beta-amylases (EC 3.2.1.2), glucan 1,4-alpha-glucosidases (EC 3.2.1.3), endo-1,4-beta-glucanase (cellulases, EC 3.2.1.4), endo-1,3(4)-beta-glucanases (EC 3.2.1.6), endo-1,4-beta-xylanases (EC 3.2.1.8), dextranases (EC 3.2.1.11), chitinases (EC 3.2.1.14), polygalacturonases (EC 3.2.1.15), lysozymes (EC 3.2.1.17), beta-glucosidases (EC 3.2.1.21), alpha-galactosidases (EC 3.2.1.22), beta-galactosidases (EC 3.2.1.23), amylo-1,6-glucosidases (EC 3.2.1.33), xylan 1,4-beta-xylosidases (EC 3.2.1.37), glucan endo-1,3-beta-D-glucosidases (EC 3.2.1.39), alpha-dextrin endo-1,6-alpha-glucosidases (EC 3.2.1.41), sucrose alpha-glucosidases (EC 3.2.1.48), glucan endo-1,3-alpha-glucosidases (EC 3.2.1.59), glucan 1,4-beta-glucosidases (EC 3.2.1.74), glucan endo-1,6-beta-glucosidases (EC 3.2.1.75), galactanases (EC 3.2.1.89), arabinan endo-1,5-alpha-L-arabinosidases (EC 3.2.1.99), lactases (EC 3.2.1.108), chitosanases (EC 3.2.1.132) and xylose isomerases (EC 5.3.1.5).

Examples of commercially available proteases (peptidases) include Kannase™, Everlase™, Esperase™, Alcalase™, Neutrase™, Durazym™, Savinase™, Ovozyme™, Pyrase™, Pancreatic Trypsin NOVO (PTN), Bio-Feed™ Pro and Clear-Lens™ Pro (all available from Novozymes A/S, Bagsvaerd, Denmark). Other preferred proteases include those described in WO 01/58275 and WO 01/58276.

Other commercially available proteases include Ronozyme™ Pro, Maxatase™, Maxacal™, Maxapem™, Opticlean™, Properase™, Purafect™ and Purafect OX™ (available from Genencor International Inc., Gist-Brocades, BASF, or DSM Nutritional Products).

Examples of commercially available lipases include Lipex™, Lipoprime™, Lipopan™, Lipolase™, Lipolase™ Ultra, Lipozyme™, Palatase™, Resinase™, Novozym™ 435 and Lecitase™ (all available from Novozymes A/S).

Other commercially available lipases include Lumafast™ (Pseudomonas mendocina lipase from Genencor International Inc.); Lipomax™ (Ps. pseudoalcaligenes lipase from Gist-Brocades/Genencor Int., Inc.; and Bacillus sp. lipase from Solvay Enzymes. Further lipases are available from other suppliers.

Examples of commercially available carbohydrases include Alpha-Gal™, Bio-Feed™ Alpha, Bio-Feed™ Beta, Bio-Feed™ Plus, Bio-Feed™ Wheat, Bio-Feed™ Z, Novozyme™ 188, Carezyme™, Celluclast™, Cellusoft™, Celluzyme™, Ceremyl™, Citrozym™, Denimax™, Dezyme™, Dextrozyme™, Duramyl™, Energex™, Finizym™ , Fungamyl™, Gamanase™, Glucanex™, Lactozym™, Liquezyme™, Maltogenase™, Natalase™, Pentopan™, Pectinex™, Promozyme™, Pulpzyme™, Novamyl™, Termamyl™, AMG™ (Amyloglucosidase Novo), Maltogenase™, Sweetzyme™ and Aquazym™ (all available from Novozymes A/S). Further carbohydrases are available from other suppliers, such as the Roxazyme™ and Ronozyme™ product series (DSM Nutritional Products), the Avizyme™, Porzyme™ and Grindazyme™ product series (Danisco, Finnfeeds), and Natugrain™ (BASF), Purastar™ and Purastar™ OxAm (Genencor).

Other commercially available enzymes include Mannaway™, Pectaway™, Stainzyme™ and Renozyme™.

Lipases: Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus) as described in EP 258 068 and EP 305 216 or from H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al. (1993), Biochemica et Biophysica Acta, 1131, 253-360), B. stearothermophilus (JP 641744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Examples of commercially available lipases include LIPEX™, LIPOPRIME™, LIPOLASE™, LIPOLASE™ Ultra, LIPOZYME™, PALATASE™, NOVOZYM™ 435 and LECITASE™ (all available from Novozymes A/S).

Other commercially available lipases include LUMAFAST™ (Pseudomonas mendocina lipase from Genencor International Inc.); LIPOMAX™ (Ps. pseudoalcaligenes lipase from DSM/Genencor Int., Inc.; and Bacillus sp. lipase from Genencor enzymes. Further lipases are available from other suppliers.

Examples of commercially available carbohydrases include ALPHA-GAL™, BIO-FEED™ Alpha, BIO-FEED™ Beta, BIO-FEED™ Plus, BIO-FEED™ Plus, NOVOZYME™ 188, CELLUCLAST™, CELLUSOFT™, CEREMYL™, CITROZYM™, DENIMAX™, DEZYME™, DEXTROZYME™, FINIZYM™, FUNGAMYL™, GAMANASE™, GLUCANEX™, LACTOZYM™, MALTOGENASE™, PENTOPAN™, PECTINEX™, PROMOZYME™, PULPZYME™, NOVAMYL™, TERMAMYL™, AMG™ (Amyloglucosidase Novo), MALTOGENASE™, SWEETZYME™ and AQUAZYM™ (all available from Novozymes A/S). Further carbohydrases are available from other suppliers.

Amylases: Suitable amylases (alpha and/or beta) include those of bacterial or fungal origin. Chemically modified or protein engineered mutants are included. Amylases include, for example, alpha-amylases obtained from Bacillus, e.g., a special strain of B. licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are NATALASE™, STAINZYME™, DURAMYL™, TERMAMYL™, TERMAMYL™ ULTRA, FUNGAMYL™ and BAN™ (Novozymes A/S), RAPIDASE™, PURASTAR™ and PURASTAR OXAM™ (from Genencor International Inc.).

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include CELLUZYME™, ENDOLASE™, RENOZYME™ and CAREZYME™ (Novozymes A/S), CLAZINASE™, and PURADAX HA™ (Genencor International Inc.), and KAC-500(B)™ (Kao Corporation).

Oxidoreductases: Particular oxidoreductases in the context of the invention are peroxidases (EC 1.11.1), laccases (EC 1.10.3.2) and glucose oxidases (EC 1.1.3.4)]. An Example of a commercially available oxidoreductase (EC 1.-.-.-) is GLUZYME™ (enzyme available from Novozymes. A/S). Further oxidoreductases are available from other suppliers.

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include GUARDZYME™ (Novozymes A/S).

Mannanase: Any mannanase suitable for use in alkaline solutions can be used. Suitable mannanases include those of bacterial or fungal origin. Chemically or genetically modified mutants are included.

In a preferred embodiment the mannanase is derived from a strain of the genus Bacillus, especially Bacillus sp. I633 disclosed in positions 31-330 of SEQ ID NO:2 or in SEQ ID NO: 5 of WO 99/64619 or Bacillus agaradhaerens, for example from the type strain DSM 8721. In a more preferred embodiment of the present invention the mannanase is derived from alkalophilic bacillus.

Suitable mannanases include MANNAWAY™ (Novozymes A/S).

Pectate lyase: Any pectate lyase suitable for use in alkaline solutions can be used. Suitable pectate lyases include those of bacterial or fungal origin. Chemically or genetically modified mutants are included.

In a preferred embodiment the pectate lyase is derived from a strain of the genus Bacillus, especially a strain of Bacillus substilis, especially Bacillus subtilis DSM 14218 disclosed in SEQ ID NO: 2 or a variant thereof disclosed in Example 6 of WO 02/092741. In a more preferred embodiment of the present invention the pectate lyase is derived from Bacillus licheniformis.

In a particular embodiment of the present invention the active compound is not a pharmaceutical.

Preparation of the Granules

The particles of the invention may be formulated by any conventional formulation methods known in the art. Methods for preparing the particles include known enzyme formulation technologies, e.g., spray drying, fluid bed, fluid bed spray drying, mixer granulation and extrusion. Other relevant particles are layered products, absorbed products, pelletized products, prilled products. The particles may optionally be dried after granulation.

Methods for preparing the particle can be found in Handbook of Powder Technology; Particle size enlargement by C. E. Capes; Volume 1; 1980; Elsevier. Preparation methods include known enzyme granule formulation technologies, i.e.:

a) Spray dried products, wherein a liquid enzyme-containing solution is atomized in a spray drying tower to form small droplets which during their way down the drying tower dry to form an enzyme-containing particulate material. Very small particles can be produced this way (Michael S. Showell (editor); Powdered detergents; Surfactant Science Series; 1998; Vol. 71; page 140-142; Marcel Dekker).

b) Layered products, wherein the enzyme is coated as a layer around a pre-formed non-active core particle, wherein the enzyme comprising mixture is atomized, typically in a fluid bed apparatus wherein the pre-formed core particles are fluidized, and the enzyme comprising mixture adheres to the core particles and dries up to leave a layer of dry enzyme layer on the surface of the core particle. Particles of a desired size can be obtained this way if a useful core particle of the desired size can be found. This type of product is described in, e.g., WO 97/23606

c) Absorbed core particles, wherein rather than coating the enzyme as a layer around the core, the enzyme is absorbed onto and/or into the surface of the core. Such a process is described in WO 97/39116.

d) Extrusion or pelletized products, wherein an enzyme-containing paste is pressed to pellets or under pressure is extruded through a small opening and cut into particles which are subsequently dried. Such particles usually have a considerable size because of the material in which the extrusion opening is made (usually a plate with bore holes) sets a limit on the allowable pressure drop over the extrusion opening. Also, very high extrusion pressures when using a small opening increase heat generation in the active compound paste, which is harmful to the active compound. (Michael S. Showell (editor); Powdered detergents; Surfactant Science Series; 1998; Vol. 71; page 140-142; Marcel Dekker)

e) Prilled products, wherein an enzyme powder is suspended in molten wax and the suspension is sprayed, e.g., through a rotating disk atomizer, into a cooling chamber where the droplets quickly solidify (Michael S. Showell (editor); Powdered detergents; Surfactant Science Series; 1998; Vol. 71; page 140-142; Marcel Dekker). The product obtained is one wherein the active compound is uniformly distributed throughout an inert material instead of being concentrated on its surface. U.S. Pat. Nos. 4,016,040 and 4,713,245 also relate to this technique.

f) Mixer granulation products, wherein an enzyme liquid is added to a dry powder composition of conventional granulating components. The liquid and the powder in a suitable proportion are mixed and as the moisture of the liquid is absorbed in the dry powder, the components of the dry powder will start to adhere and agglomerate and particles will build up, forming granulates comprising the active compound. Such a process is described in U.S. Pat. No. 4,106,991 (Novo Nordisk) and related documents EP 170360 B1 (Novo Nordisk), EP 304332 B1 (Novo Nordisk), EP 304331 (Novo Nordisk), WO 90/09440 (Novo Nordisk) and WO 90/09428 (Novo Nordisk). In a particular product of this process wherein various high-shear mixers can be used as granulators, granulates consisting of enzyme as active compound, fillers and binders, etc. are mixed with cellulose fibers to reinforce the particles to give the so-called T-granulate. Reinforced particles, being more robust, release less enzymatic dust.

g) Size reduction, wherein the cores are produced by milling or crushing of larger particles, pellets, tablets, briquettes, etc. containing the active material. The wanted core particle fraction is obtained by sieving the milled or crushed product. Over and undersized particles can be recycled. Size reduction is described in (Martin Rhodes (editor); Principles of Powder Technology; 1990; Chapter 10; John Wiley & Sons).

h) Fluid bed granulation. Fluid bed granulation involves suspending particulates in an air stream and spraying an enzyme liquid onto the fluidized particles via nozzles. Particles hit by spray droplets get wetted and become tacky. The tacky particles collide with other particles and adhere to them and form a granule.

i) The cores may be subjected to drying, such as in a fluid bed drier. Other known methods for drying granules in the enzyme industry can be used by the skilled person. The drying preferably takes place at a product temperature of from 25 to 90° C. For some enzymes it is important the cores comprising the enzymes contain a low amount of water before coating with the salt. If water sensitive active compounds are coated with a salt before excessive water is removed, it will be trapped within the core and it may affect the activity of the enzyme negatively. After drying, the cores preferably contain 0.1 -10% w/w water.

Conventional coatings and methods as known to the art may suitably be used, such as the coatings described in WO 03/080827, WO 89/08694, WO 89/08695, EP 270608 B1 and/or WO 00/01793. Other examples of conventional coating materials may be found in US 4,106,991, EP 170360, EP 304332, EP 304331, EP 458849, EP 458845, WO 97/39116, WO 92/12645A, WO 89/08695, WO 89/08694, WO 87/07292, WO 91/06638, WO 92/13030, WO 93/07260, WO 93/07263, WO 96/38527, WO 96/16151, WO 97/23606, WO 01/25412, WO 02/20746, WO 02/28369, U.S. Pat. No. 5879920, U.S. Pat. No. 5,324,649, U.S. Pat. No. 4,689,297, U.S. Pat. No. 6,348,442, EP 206417, EP 193829, DE 4344215, DE 4322229 A, DE 263790, JP 61162185 A and/or JP 58179492.

The granules obtained can be subjected to rounding off (e.g., spheronization), such as in a Marumeriser™, or compaction.

Adjustment of the Activity Strength of a Granulate

The activity strength of the finished granulate is obtained by mixing the inactive particles with the particles comprising the active compounds.

The particles can be mixed before or after applying a coating to the particles. If different amounts of coating have to be applied or it is only one kind of particles that has to be coated, it can be necessary to coat the particles which need a coating before blending the different particles. If both kinds of particles are to be coated with the same coating, it is an advantage to coat them together after blending to avoid one process step, and to obtain particles with the most similar appearance.

In a particular embodiment of the present invention the invention further relates to a method for preparing a blend comprising inactive particles and particles comprising active compounds comprising the following steps:

(i) preparing inactive particles;

(ii) preparing particles comprising an active compound;

(iii) Mixing the particles of i) and the particles of ii) to a particulate composition.

Activity can thus be adjusted by changing the percentage of inactive particles.

The present invention may further comprise a coating step in i) and/or ii) or it may comprise a coating step iv).

The method of the present invention may further comprise the steps of:

(v) determining a desired specific activity strength of the final particulate composition; and

(vi) selecting the amount of particles of i) and the particles of ii) in the right ratio as to obtain the desired specific activity strength determined in v).

The method may in a particular embodiment include adjustment of the amount of coating applied to the particles so as to lower the segregation when blending the two kinds of particles.

The blend of the present invention is in particular a premix or intermediary product suitable for mixing with another particulate composition or liquid formulation so as to produce a final product, e.g., a detergent composition, a feed for animal or a dough composition.

The present invention thus comprises a method for preparing a first particulate composition of particles comprising an active compound and inactive particles, said method comprising:

i) preparing particles comprising an active compound;

ii) preparing inactive particles comprising a coating;

iii) blending the particles of i) and ii) to obtain a first particulate composition;

iv) mixing the first particulate composition of iii) with a second composition at least one day after preparing the first particulate composition.

In a particular embodiment of the present invention the first particulate composition of iii) is mixed with a second composition at least 7 days after preparing the first particulate composition. Such as at least 14 days after preparing the first particulate composition. Even at least 1 month after preparing the first particulate composition.

The blend of the present invention is expected to be shipped from the place of mixing the two kinds of particles to another geographic location for further processing into a final product.

In a particular embodiment of the present invention the mixing of the first particulate composition of iii) with a second composition is in a country separate from the country where the first particulate composition was prepared. In a more particular embodiment of the present invention the first particulate composition is stored and/or shipped to another geographic location prior to mixing it to a second composition.

Compositions Comprising the Coated Particle and Their Application

The invention also relates to compositions comprising the particle mixture of the invention. The composition may be any composition which may benefit from comprising the particle blend. Suitable compositions may be but are not limited to detergent compositions, pharmaceutical compositions, compositions for use in the textile, leather or paper industry, compositions for use in the feed or food industry and in the baking industry. Accordingly the compositions may be a feed composition, a food composition, a baking composition, a detergent composition, a pharmaceutical composition or an additive to be incorporated in such compositions. The particles of the invention may be used within the pharmaceutical area, in detergent compositions for cleaning an object, in textile production, in baking for improving bread, in feed compositions for improving the feed and in food products, in personal care products etc.

In a particular embodiment of the present invention the invention is not to be used in tablets. In a more particular embodiment of the present invention the blend of the invention is not to be used in further processing such as compression of the blend to tablets.

Detergents

The particle blend of the present invention may be added to and thus become a component of a detergent composition.

The particle blend of the invention is preferably not a detergent composition.

The detergent composition may for example be formulated as laundry detergent composition for hand or machine washings including a cleaning additive composition suitable for pretreatment of stained fabrics or a fabric softener composition, or a detergent composition for use in general household hard surface cleaning operations, or a composition for hand or machine dishwashing operations.

In a specific aspect, the invention provides a detergent additive comprising the particle blend of the invention. The detergent additive as well as the detergent composition may comprise one or more other enzymes such as a protease, a lipase, a cutinase, an amylase, a carbohydrase, a cellulase, a pectinase, a mannanase, an arabinase, a galactanase, a xylanase, an oxidase, e.g., a laccase, and/or a peroxidase.

In general the properties of the chosen enzyme(s) should be compatible with the selected detergent (i.e., pH-optimum, compatibility with other enzymatic and non-enzymatic ingredients, etc.), and the enzyme(s) should be present in effective amounts.

Proteases: Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235 and 274.

Preferred commercially available protease enzymes include EVERLASE™, OVOZYME™, SAVOZYME™, ALCALASE™, SAVINASE™, PRIMASE™, DURALASE™, ESPERASE™, and KANNASE™ (Novozymes A/S), MAXATASE™, MAXACAL™, MAXAPEM™, PROPERASE™, PURAFECT™, PURAFECT OXP™, FN2™, FN3™ and FN4™ (Genencor International Inc.).

Lipases: Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus) as described in EP 258 068 and EP 305 216 or from H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include LIPOLASE™ and LIPOLASE ULTRA™ (Novozymes A/S).

Amylases: Suitable amylases (alpha and/or beta) include those of bacterial or fungal origin. Chemically modified or protein engineered mutants are included. Amylases include, for example, alpha-amylases obtained from Bacillus, e.g., a special strain of B. licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are DURAMYL™, TERMAMYL™, FUNGAMYL™ and BAN™ (Novozymes A/S), RAPIDASE™, PURASTAR™ and PURASTAR OXAM™ (from Genencor International Inc.).

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include CELLUZYME™ and CAREZYME™ (Novozymes A/S), CLAZINASE™ , and PURADAX HA™ (Genencor International Inc.), and KAC-500(B)™ (Kao Corporation).

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include GUARDZYME™ (Novozymes A/S).

Mannanase: Suitable mannanases include MANNAWAY™ (Novozymes A/S).

The detergent composition may be in any convenient dry form, e.g., a bar, a tablet, a powder, a granule or a paste. It may also be a liquid detergent, in particular non-aqueous liquid detergent.

The detergent composition comprises one or more surfactants, which may be non-ionic including semi-polar and/or anionic and/or cationic and/or zwitterionic. The surfactants are typically present at a level of from 0.1% to 60% by weight.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the detergent will usually contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

The detergent may contain 0-65% of a detergent builder or complexing agent such as zeolite, diphosphate, triphosphate, phosphonate, carbonate, citrate, nitrilotriacetic acid, ethylenediaminetetraacetic acid, diethylenetriaminepentaacetic acid, alkyl- or alkenylsuccinic acid, soluble silicates or layered silicates (e.g., SKS-6 from Hoechst).

The detergent may comprise one or more polymers. Examples are carboxymethylcellulose, poly(vinylpyrrolidone), poly(ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid copolymers.

The detergent may contain a bleaching system, which may comprise a H₂O₂ source such as perborate or percarbonate, which may be combined with a peracid-forming bleach activator such as tetraacetylethylenediamine or nonanoyloxybenzenesulfonate. Alternatively, the bleaching system may comprise peroxyacids of, e.g., the amide, imide, or sulfone type.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, e.g., WO 92/19709 and WO 92/19708.

The detergent may also contain other conventional detergent ingredients such as, e.g., fabric conditioners including clays, foam boosters, suds suppressors, anti-corrosion agents, soil-suspending agents, anti-soil redeposition agents, dyes, bactericides, optical brighteners, hydrotropes, tarnish inhibitors, or perfumes.

It is at present contemplated that in the detergent compositions any enzyme, may be added in an amount corresponding to 0.01-100 mg of enzyme protein per liter of wash liquor, preferably 0.05-5 mg of enzyme protein per liter of wash liquor, in particular 0.1-1 mg of enzyme protein per liter of wash liquor.

The blend of the invention may additionally be incorporated in the detergent formulations disclosed in WO 97/07202, which is hereby incorporated as reference.

### EXAMPLES

The particle size can be changed by applying coatings with deviating density. The density of the final particle will be in between the density of the core and the density of the coating. Several different coating layers may also be applied. Variation of core and coating size will provide particle densities varying between the core and the coating density. This way, inactive granulates can be produced with the required particle densities in order to avoid segregation. Besides, a thick coating also provides equal visual appearance between the inactive particles and the active granulate.

### Example 1

Sodium sulphate cores with a density of 2.67 g/ml were coated with a sodium sulphate slurry. The density of the coating was 2.03 g/ml. The particle size was increased from the initial 300 micron to 400 micron due to the coating, leading to a final particle density of 2.3 g/ml.

This is an example on how lower densities can be obtained by increasing the size of the coating relative to the size of the core.

### Example 2

56% of the volume of the above described salt coating was exchanged by a starch coating, with a coating density of 1.43 g/ml. This resulted in a final particle density of only 2.1 g/ml. The size of the coated particle was 400 microns.

This is an example on how lower particle densities can be obtained by applying low density coatings to a high density core particle.

### Example 3

10% V/V coating of a sodium sulphate slurry applied onto salt cores only changed the visual appearance of the inactive core particles slightly. 200% v/v of sodium sulphate slurry was applied onto salt cores and the appearance change completely whereby the inactive particles could not visually be distinguished from the particles comprising active compounds, which were also coated with a thick sodium sulphate coating.

The coating changed the appearance of sodium sulphate salt core particles from semi-transparent crystals to non-transparent particles. Mixed with other coated, active particles, the inactive particles were visually indistinguishable from the active particles in the mixture.

### Example 4

The inactive particles may differ in particle density from the particles comprising the active ingredient. If the difference is large enough, segregation of the two components may occur for equally sized granulates. The segregation can be reduced by varying the size of the inactive particles relative to the size of the active particles.

The table below shows the segregation coefficient of a 50:50 mixture of active particles and inactive particles with a particle density ratio of 0.8.

The particle size of the active comprising particles is 450 microns. The particle size of the inactive particles is varied between 450 and 650 microns. The particle density of the active comprising particles is 2.1 g/ml, while the density of the inactive comprising particles is 2.67 g/ml.

| | | | Segregation |
|---|---|---|---|
| d50 active | d50 inactive | Segregation coeff. | coeff. |
| particles (micron) | particle (micron) | Heap Test | Rolling Bed |
| 450 | 450 | 0.25 | — |
| 450 | 500 | 0.08 | 0.17 |
| 450 | 560 | 0.07 | 0.02 |
| 450 | 630 | 0.33 | 0.13 |

Table 1 shows the segregation coefficient measured both by heap test and rolling bed as a function of the size ratio between the inactive granules and the active granules. The particle density ratio between the two granulates is 0.8.

From table 1 it is seen that by varying the particle size when having different particle densities of the inactive and active particles, it is possible to avoid segregation.

### Example 5

The particle density of the active comprising particles was 2.1 g/ml, while the density of the inactive comprising particles was varied from 2.67 g/ml to 2.3 and 2.1 g/ml, where the particle with a density of 2.67 g/ml was a salt particle of 400 microns. The particle density was lowered by means of coatings: a core particle of 300 micron with density 2.67 g/ml was coated up to 400 micron with sodium sulphate slurry. Exchanging 56% of the coating with a starch coating resulted in particles with density 2.1 g/ml. The particle size of the active and inactive particles was all 400 microns. The table below shows the segregation coefficient of 1:1 mixtures of active and inactive particles.

| ρ_{active} (g/ml) | ρ_{inactive} (g/ml) | Segregation Coefficient |
|---|---|---|
| 2.1 | 2.67 | 0.25 (Heap test) |
| 2.1 | 2.3 | 0.19 (Rolling bed) |
| 2.1 | 2.1 | 0.03 (Rolling bed) |

### Example 6

The color of particles comprising an enzyme and the color of simple salt cores were measured. The size of the particles was 300 to 400 microns. The color Lab-values were measured with a HunterLab DP 9000 Model D25M Optical sensor. Before coating, the difference in appearance of the two granulates is very large as seen from the ΔE in the table below

| | Na2SO4 particles | Enzyme particles | Delta values |
|---|---|---|---|
| L | 92.5 | 78.8 | 13.7 |
| a | −0.23 | 0.77 | −1 |
| b | 2.9 | 8.3 | −5.7 |
| E | | | 14.9 |

After coating with 200% salt coating, the difference is negligible and the ΔE is below 6.

### Example 7

### Preparation of Protease/placebo Products and Mixtures

P1: Savinase prills (active)

Spray-dried Protease (Savinase) powder is mixed with Na-sulfate powder and molten Lutensol AT-80 wax and spray-cooled to obtain spherical prills:
Average particle size: 273 microns
Particle density: 1.51 g/ml
Color L,a,b: 78.1, −0.29, 19.1
   P2: Un-coated Na-sulfate rounded beads from Minera Santa Marta (placebo):

Average particle size: 370 microns
Particle density: 2.71 g/ml
Color L,a,b: 93.6, −0.17, 1.69
   P3: Coated Savinase (active):

Savinase prills (P1) were coated on a fluid bed (Aeromatic MP-1) by spraying aqueous slurry of 50% Na-sulfate and 2% Avebe W80 dextrin onto the prills resulting in the following product:
Average particle size: 443 microns
Particle density: 2.27 g/ml
Color L,a,b: 87.7, −0.66, 11.0
(The coating constitutes 85% of the final particle)
   P4: Coated Na-sulfate beads (placebo)

Na-sulfate beads (P2) were coated on a fluid bed (Aeromatic MP-1) by spraying aqueous slurry of 33% Na-sulfate, 5% TiO₂ and 2.5% Avebe W80 dextrin onto the beads resulting in the following product:
Average particle size: 524 microns
Particle density: 2.55 g/ml
Color L,a,b: 91.0, 0.33, 4.13
The coating constitutes 63% of the final particle

Mixtures of active and placebo were prepared:

| Particle mix | Hunter Lab | | |
|---|---|---|---|
| (1:1 vol/vol) | ΔE-value | (ρ_{pI}/ρ_{pA}) · (D_{pA}/D_{pI}) | Visual appearance |
| P1:P2 | 23.3 | 1.32 | Clearly |
| | | | inhomogeneous |
| P3:P2 | 11.0 | 1.43 | Clearly |
| | | | inhomogeneous |
| P3:P4 | 7.7 | 0.95 | Homogenous |

From this example it is clear that mixing the active granules (P1 or P3) with the un-coated placebo (P2) results in a large ΔE value, a ratio (ρ_{pI}/ρ_{pA})·(D_{pA}/D_{pI}) not close to 1.0, and a visual inhomogeneous mixture. By making an extensive coating of the placebo (P4) a much lower ΔE, a ratio (ρ_{pI}/ρ_{pA})·(D_{pA}/D_{pI}) close to 1.0 and a homogeneous mixture is obtained when mixed with the coated active granule.

1. A blend of particles comprising at least two different kinds of particles:
(a) particles comprising an active compound; and
(b) inactive particles comprising a coating.

2. The blend of claim 1, wherein the active compound is a protein.

3. The blend of claim 2, wherein the protein is an enzyme.

4. The blend of claim 1, wherein the particles have a mean particle size of 100 to 1500 micro-m.

5. The blend of claim 1, wherein the inactive particles and the particles comprising an active compound have a particle density ratio between 0.4 and 2.5.

6. The blend of claim 1, wherein the inactive particles and the particles comprising an active compound have a particle size ratio between 0.4 and 2.5.

7. The blend of claim 1, wherein the inactive particles and the particles comprising an active compound have a span not more than 2.5.

8. The blend of claim 1, wherein the color difference ΔE of the inactive particles and the particles comprising an active compound is less than 6.

9. The blend of claim 1, wherein (ρ_{pI}/ρ_{pA})·(D_{pA}/D_{pI}) are in between 0.9 and 1.1.

10. The blend of claim 1, wherein the inactive particles and the particles comprising an active compound have a delta E value of less than 6.

11. The blend of claim 1, wherein the inactive particles and the particles comprising an active compound has a segregation coefficient of less than 0.3.

12. The blend of claim 1, wherein the particles comprising an active compound consist of a core comprising the active compound and a coating.

13. The blend of claim 1, wherein the two kinds of particles are coated with the same coating.

14. The blend of claims 1, wherein the coating is at least 25 micro-m thick.

15. The blend of claims 1, wherein the coating is at least 5% w/w of the total particle.

16. The blend of claims 1, wherein the ratio between the diameter of the particle and the diameter of the core is at least 1.1.

17. The blend of claim 12, wherein the core comprises a component selected from the group consisting of salt, sugar, sugar alcohols, organic acids, organic salts, starch, cellulose, polysaccharides, clays and silicates.

18. The blend of claim 12, wherein the coating comprises a component selected from the group consisting of salt, polysaccharides, synthetic polymers, wax and fat.

19. A method for preparing a blend of claim 1, comprising inactive particles and particles comprising active compounds comprising the following steps:
i) preparing inactive particles;
ii) preparing particles comprising an active compound;
iii) mixing the particles of i) and the particles of ii) to a particulate composition,
and wherein the inactive particles comprise a coating.

20-41. (canceled)

42. A method for preparing a first particulate composition of particles comprising an active compound and inactive particles, said method comprising:
(a) preparing particles comprising an active compound;
(b) preparing inactive particles comprising a coating;
(c) blending the particles of a) and b) to obtain a first particulate composition; and
(d) mixing the first particulate composition of claim c) to a second composition at least one day after preparing the first particulate composition.

43-47. (canceled)
